(19) United States
(12) Patent Application Publication
(10) Pub. No.: US 2014/0308866 A1
(43) Pub. Date: Oct. 16, 2014

(54) Acid Resistant Fibers.of Polyarylene and Polymethylpentene

(71) Applicant: E I DU PONT DE NEMOURS AND COMPANY, Wilmington, DE (US)

(72) Inventors: RAKESH NAMBIAR, WEST CHESTER, PA (US); HARRY VAUGHN SAMUELSON, CHADDS FORD, PA (US)

(73) Assignee: E I DU PONT DE NEMOURS AND COMPANY, Wilmington, DE (US)

(21) Appl. No.: 13/860,076

(22) Filed: Apr. 10, 2013

(51) Int. Cl. C08L 81/04; D01F 8/10; D01F 8/16

(52) U.S. Cl. CPC C08L 81/04; D01F 8/16; D01F 8/10
USPC 442/187; 525/189; 428/373; 442/333

(57) ABSTRACT

A multicomponent fiber having an exposed outer surface with the fiber having at least a first component of polyarylene sulfide polymer; and at least a second component of a thermoplastic polymer free of polyarylene sulfide polymer, wherein said thermoplastic polymer forms the entire exposed surface of the multicomponent fiber and is polymethylpentene.

### BACKGROUND OF THE INVENTION

1. Field of the Invention

The present invention relates to fibers having a polyarylene sulfide component and products including the same.

2. Description of the Related Art

Filtration processes are used to separate compounds of one phase from a fluid stream of another phase by passing the fluid stream through filtration media, which traps the entrained or suspended matter. The fluid stream may be either a liquid stream containing a solid particulate or a gas stream containing a liquid or solid aerosol.

For example, filters are used in collecting dust emitted from incinerators, coal fired boilers, metal melting furnaces and the like. Such filters are referred to generally as “bag filters.” Because exhaust gas temperatures can be high, bag filters used to collect hot dust emitted from these and similar devices are required to be heat resistant. Bag filters can also be used in chemically corrosive environments. Thus, dust collection environments can also require a filter bag made of materials that exhibit chemical resistance. Examples of common filtration media include fabrics formed of aramid fibers, polyimide fibers, fluorine fibers and glass fibers.

Polyphenylene sulfide (PPS) polymers exhibit thermal and chemical resistance. As such, PPS polymers can be useful in various applications. For example, PPS can be useful in the manufacture of molded components for automobiles, electrical and electronic devices, industrial/mechanical products, consumer products, and the like PPS has also been proposed for use as fibers for filtration media, flame resistant articles, and high performance composites. Despite the advantages of the polymer, however, there are difficulties associated with the use of fibers from PPS because PPS has limited resistance to extremely acid environments.

What is needed is a fiber that combines the high temperature properties of PPS that can be used in acidic environments.

### SUMMARY OF THE INVENTION

In one embodiment, the present invention is directed to a multicomponent fiber having an exposed outer surface, comprising: at least a first component of polyarylene sulfide polymer; and at least a second component of a thermoplastic polymer free of polyarylene sulfide polymer, wherein said thermoplastic polymer forms the entire exposed surface of the multicomponent fiber and consists essentially of polymethylpentene.

The invention is further directed to a method for increasing the acid resistance of any of the embodiments of a polyarylene fiber described herein by providing it with a coating of the second component in any of the embodiments described herein.

In particular the method for improving the acid resistance of a fiber comprises the steps of;
i. providing a fiber,
ii. coating the fiber with a thermoplastic polymer that is free of polyarylene sulfide polymer to from a coated fiber, wherein said thermoplastic polymer forms the entire exposed surface of the coated fiber and consists essentially of a polymethyl pentene,

said fiber comprising: at least a first component of polyarylene sulfide polymer.

### BRIEF DESCRIPTION OF THE FIGURES

FIG. 1 is a transverse cross sectional view of an exemplary fiber configuration useful in the present invention.

FIG. 2 illustrates a cross sectional view of an islands-in-the-sea fiber.

FIG. 3 illustrates an embodiment with multilobal structure.

### DETAILED DESCRIPTION OF THE INVENTION

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

For purposes of illustration only, the present invention will generally be described in terms of a bicomponent fiber comprising two components. However, it should be understood that the scope of the present invention is meant to include fibers with two or more structured components.

In one embodiment the invention is directed to a multicomponent fiber having an exposed outer surface. The fiber comprises: at least a first component of polyarylene sulfide polymer; and at least a second component of a thermoplastic polymer free of polyarylene sulfide polymer, wherein said thermoplastic polymer forms the entire exposed surface of the multicomponent fiber. The second component consists essentially of polymethylpentene (PMP.) By “consists essentially of” is meant that any additional component does not detract from the performance of the structure.

The fiber of the invention has an unexpectedly high resistance to acid compared to polyarylene sulfide alone, and this result is unexpected because PMP is recognized as having a high permeability, as evidenced by its permeability to oxygen. (Data supplied by the manufacturer, Mitsui Chemicals showing the permeability of PMP.)

The polyarylene sulfide polymer may comprise in one embodiment a polymer in which at least 85 mol % of the sulfide linkages are attached directly to two aromatic rings.

In a further embodiment the polyarylene sulfide polymer is polyphenylene sulfide.

The second component may be present at a 10 to 30% by weight of the total polyarylene sulfide plus thermoplastic polymer. In a further embodiment the second component may comprise less than about 30 percent by weight or even 20% by weight of the total weight of the fiber.

The fiber may be a continuous filament or a staple fiber. It may also be a spunbond fiber or a meltblown fiber.

The fiber may be a bicomponent fiber comprising a sheath component and a core component, wherein said sheath component forms the entire exposed outer surface of said fiber and comprises said thermoplastic polymer free of polyarylene sulfide polymer, and wherein said core component comprises polyarylene sulfide polymer. In a further embodiment the bicomponent fiber has a concentric sheath/core cross section. In a still further embodiment the bicomponent fiber has an eccentric sheath/core cross section.

The fiber may be an islands-in-the-sea fiber comprising a sea component and a plurality of island components distributed within said sea component, wherein said sea component forms the entire exposed outer surface of said fiber and comprises said thermoplastic polymer free of polyarylene sulfide polymer, and wherein said plurality of island components comprises polyarylene sulfide polymer.

The invention is also directed to a web comprising the fiber of any of the embodiments described above. The web may comprise a woven or nonwoven material. The web may also be made by a spunbond or meltblown process.

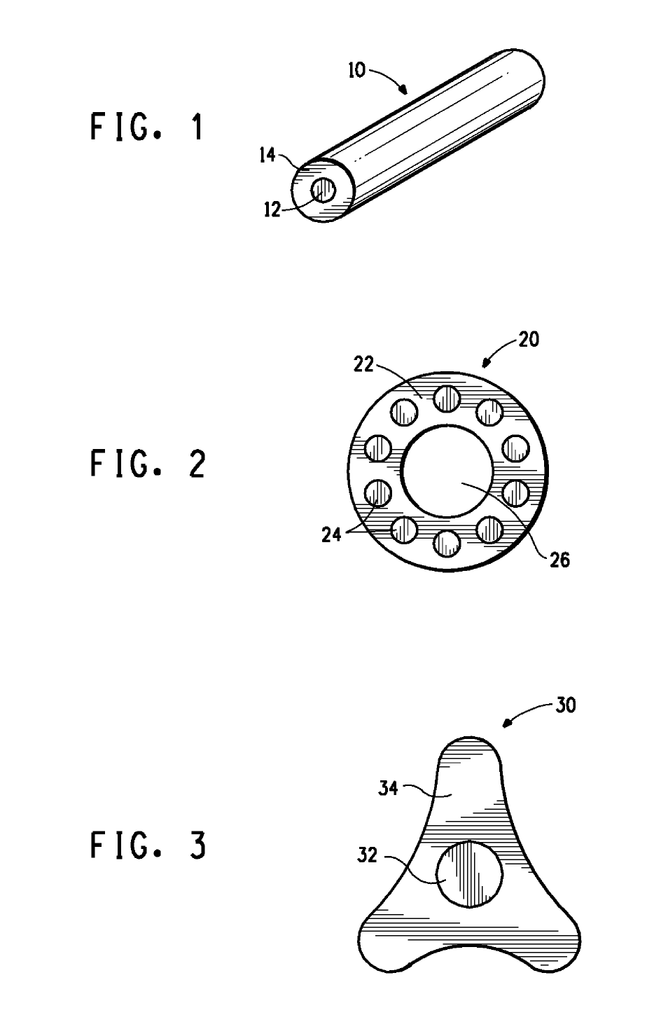

Turning now to the figures, FIG. 1 is a transverse cross sectional view of an exemplary fiber configuration useful in the present invention. FIG. 1 illustrates a bicomponent fiber 10 having an inner core polymer domain 12 and surrounding sheath polymer domain 14. Sheath component 14 is formed of a thermoplastic polymer free of polyarylene sulfide polymer. Core component 12 is formed of polyarylene sulfide polymer. In the present invention, sheath 14 is continuous, e.g., completely surrounds core 12 and forms the entire outer surface of fiber 10. Core 12 can be concentric, as illustrated in FIG. 1. Alternatively, the core can be eccentric, as described in more detail below. Also, it should be recognized that due to processing variability, a small portion of the sheath could be contacted by the polyarylene sulfide polymer, however it is believed that there would only be minimal effect on spinning ability. Regardless, the sheath should be as virtually free of polyarylene sulfide polymer.

Other structured fiber configurations as known in the art can also be used, so long as the thermoplastic polymer free of polyarylene sulfide polymer forms the entire exposed outer surface of the fiber. As an example, another suitable multicomponent fiber construction includes “islands-in-the-sea” arrangements. FIG. 2 illustrates a cross sectional view of one such islands-in-the-sea fiber 20. Generally islands-in-the-sea fibers include a “sea” polymer component 22 surrounding a plurality of “island” polymer components 24. The island components can be substantially uniformly arranged within the matrix of sea component 22, such as illustrated in FIG. 2. Alternatively, the island components can be randomly distributed within the sea matrix.

Sea component 22 forms the entire outer exposed surface of the fiber and is formed of a thermoplastic polymer free of polyarylene sulfide polymer. As with core component 12 of sheath core bicomponent fiber 10, island components 24 are formed of polyarylene sulfide polymer. The islands-in-the-sea fiber can optionally also include a core 26, which can be concentric as illustrated or eccentric as described below. When present, core 26 is formed of any suitable fiber-forming polymer.

The fibers of the invention also include multilobal fibers having three or more arms or lobes extending outwardly from a central portion thereof. FIG. 3 is a cross sectional view of an exemplary multilobal fiber 30 of the invention. Fiber 30 includes a central core 32 and arms or lobes 34 extending outwardly therefrom. The arms or lobes 34 are formed of a thermoplastic polymer free of polyarylene sulfide polymer and central core 32 is formed of polyarylene sulfide polymer. Although illustrated in FIG. 3 as a centrally located core, the core can be eccentric.

Any of these or other multicomponent fiber constructions may be used, so long as the entire exposed outer surface of the fiber is formed of the thermoplastic polymer free of polyarylene sulfide polymer.

The cross section of the fiber is preferably circular, since the equipment typically used in the production of synthetic fibers normally produces fibers with a substantially circular cross section. In bicomponent fibers having a circular cross section, the configuration of the first and second components can be either concentric or acentric, the latter configuration sometimes being known as a “modified side-by-side” or an “eccentric” multicomponent fiber.

Advantageously, the sheath/core fibers of the invention are concentric fibers, and as such will generally be non-self crimping or non-latently crimpable fibers. The concentric configuration is characterized by the sheath component having a substantially uniform thickness, such that the core component lies approximately in the center of the fiber, such as illustrated in FIG. 1. This is in contrast to an eccentric configuration, in which the thickness of the sheath component varies, and the core component therefore does not lie in the center of the fiber. Concentric sheath/core fibers can be defined as fibers in which the center of the core component is biased by no more than about 0 to about 20 percent, preferably no more than about 0 to about 10 percent, based on the diameter of the sheath/core bicomponent fiber, from the center of the sheath component.

Islands-in-the-sea and multi-lobal fibers of the invention can also include a concentric core component substantially centrally positioned within the fiber structure, such as cores 26 and 32 illustrated in FIGS. 2 and 3, respectively. Alternatively, the additional polymeric components can be eccentrically located so that the thickness of the surrounding thermoplastic polymer free of polyarylene sulfide polymer component varies across the cross section of the fiber.

Any of the additional polymeric components can have a substantially circular cross section, such as components 12, 24 and 32 illustrated in FIGS. 1, 2 and 3, respectively. Alternatively, any of the additional polymeric components of the fibers of the invention can have a non-circular cross section.

Polyarylene sulfides include linear, branched or cross linked polymers that include arylene sulfide units. Polyarylene sulfide polymers and their synthesis are known in the art and such polymers are commercially available.

Exemplary polyarylene sulfides useful in the invention include polyarylene thioethers containing repeat units of the formula —[(Ar¹)ₙ—X]ₘ—[(Ar²)ᵢ—Y]ⱼ—(Ar³)ₖ—Z]ₗ[(Ar⁴)ₒ—W]ₚ— wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes at least 30 mol %, particularly at least 50 mol % and more particularly at least 70 mol % arylene sulfide (—S—) units. Preferably the polyarylene sulfide polymer includes at least 85 mol % sulfide linkages attached directly to two aromatic rings. Advantageously the polyarylene sulfide polymer is polyphenylene sulfide (PPS), defined herein as containing the phenylene sulfide structure —(C₆H₄—S)ₙ— (wherein n is an integer of 1 or more) as a component thereof.

At least one other of the polymeric components includes polymethylpentene. While mixtures of the polymers may be used, the at least one other polymeric component does not include a polyarylene sulfide polymer as defined above.

The invention is further directed to a method for increasing the acid resistance of any of the embodiments of a polyarylene fiber described herein by providing it with a coating of the second component in any of the embodiments described herein.

In particular the method for improving the acid resistance of a fiber comprises the steps of;
i. providing a fiber,
ii. coating the fiber with a thermoplastic polymer that is free of polyarylene sulfide polymer to from a coated fiber, wherein said thermoplastic polymer forms the entire exposed surface of the coated fiber and consists essentially of polymethyl pentene,

said fiber comprising at least polyarylene sulfide polymer.

### EXAMPLES

### Masterbatch

A PPS composition containing 11.0 weight percent Zinc Octoate was produced using an extrusion process. Fortron ®0309 PPS (89 parts) was melt compounded in a Coperion 18 mm intermeshing co-rotating twin-screw extruder with a liquid metering pump adding Zinc Octoate (11 parts) down stream into the melted polymer. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was frozen in a 6 ft tap water trough prior to being pelletized to give a pellet count of 100-120 pellets per gram.

### Spinning Experiment

In general, polymers are made into fibers by melting the polymer and pushing this viscous fluid through several small orifices as a collection to produce a multifiber yarn. The diameter of the fibers, usually expressed as denier which is the weight of 9000 meters of fiber [or yarn], is established by how fast the polymer is feed through the orifices and how fast this collection is pulled away from the orifices. This pulling with the diameter reduction step mostly occurs where this viscous polymer fluid has cooled sufficiently to again become solid. The pulling is accomplished by wrapping the solid fibers around a rotating roll several times, where either a non-driven roll, aka idler roll, or a second roll driven at the same speed are used in tandem; to permit the several turns or wrappings of the fiber ‘threadline’ to be spaced from each other the two rolls are canted with regard to each other. This prevents threadline cross overs which can breakdown a continuous removal of the fibers to a next set of rolls for further processing. The fibers are usually wrapped several times around rolls to produce sufficient drag or resisting friction that the fibers maintain the roll speeds without slipping. The fiber diameters may be further reduced by a ‘drawing’ step, where yarns are drawn, aka extended in length, from the one roll (or a pair) rotating at one speed to another (or pair) moving at a higher speed. This would be a single stage draw.

When the draw process is repeated more than once with additional rolls, this is a multistage draw. A draw assist device may be used between pairs of rolls such as a heated pin or plate, or a hot gas jet which impinges on the yarn. Rolls can also severe other functions such as forwarding the fibers from one position to another. In undrawn fibers such a partially oriented yarns (POY), the rolls serve the purpose to bring the fibers to a speed that will match their winding speed where the fibers are collected on bobbins. Frequently the winding speed will be slightly less than the feeding speed to keep winding tension sufficiently low that fibers do not relax some of their elasticity on the packaged bobbin, and give a poorly formed package. This tension adjustment is also a consideration with drawn fibers.

With drawn fibers, the draw process might benefit fiber properties, or the process, if they are heated, or from heating after the draw on additional rolls as an ‘annealing’ step. Semi-crystalline polymers, as opposed to amorphous, develop crystallinity in the draw and annealing steps. In general, higher crystallinity gives lower shrinkage, frequently an essential property for fibers. While the temperature of the rolls is sometimes used as a drawing assist, roll temperature can impact final crystallinity and shrinkage. Without annealing, small amounts of fibers can be wound on bobbins without detriment where an elastic recovery hasn't built sufficient force to affect bobbin quality, which might occur on bigger bobbins, i.e. more fiber length on the bobbin. After the draw step additional rolls, if used, will general spin at slower speeds to let down the elasticity in the fibers with or without heat.

When heated for fiber annealing, an increase in crystallinity at this stage also causes the fibers to want to shrink, and roll speeds are usually lowered in speed to accommodate the tension which is developed from fiber shrinkage. Annealed fibers have less final shrinkage and also have less elasticity memory when transferred to the bobbin which can give better large bobbins. Historically, this is called a continuous filament process.

### Comparative Fiber Example 1

In this example, a fiber was made from polyphenylene sulfide component. The resin is available from Ticona as Fortran PPS 309. Before fibers were spun the resin was dried for 16 hours at 100° C. in a vacuum oven with a dry nitrogen sweep. The dried polymer pellets were metered into a Werner and Pfleiderer 28 mm twin screw extruder and spun through a 34-hole spinneret orifice of 0.012 inch (0.030 mm) diameter and 0.048 inch (1.22 mm) length. The extruder was heated in the feed zone to 190° C. then to melt zones at 275 then 285° C., then transfer zones at 285° C. and then to Zenith pumps (available Zenith Pumps, Monroe, N.C.) at 285° C. and then pushed and transferred to the spinneret pack block at 290° C. A ring heater was used at 290° C. around the pack nut that holds the spinneret. After simple cross flow air quenching, the undrawn yarns were processed as described below. The wind up unit was a Barmag SW 6.

The speed of the gear pump on the sheath side was preset so as to supply 32.8 g/min of the PPS to the spinneret. The polymer stream was filtered through three 200 mesh screens sandwiched between 50 mesh screens within the pack, and after filtration, a total of 34 individual fibers/filaments were created at the spinneret orifice outlets with the sheath-core cross section. These 34 resulting filaments were cooled in ambient air quench zone, given an aqueous oil emulsion (10% oil) finish, and then combined in a guide approximately eight feet (˜7 meters) below the spin pack. The 34 filament yarn was pulled away from the spinneret orifices and through the guide by a roll with an idler roll turning at approximately 527 meters/minute. From these rolls the yarn was taken to a pair of rolls also at 537 meters/minute, then through a steam jet at 170 C, then to a pair of rolls at 1900 meters/minute heated at 125° C., then to a pair of rolls at 1900 meters/minute at room temperature then to a pair of let down rolls and to the windup. The denier on this fiber was 110.

### Comparative Fiber Example 2

In this example, a fiber was made from polyphenylene sulfide component with a stabilizer Zinc Octoate. The resin is available from Ticona as Fortran PPS 309. Before fibers were spun the PPS resin and Masterbatch A was dried for 16 hours at 100° C. in a vacuum oven with a dry nitrogen sweep. A combination of dried polymer pellets in the ratio of (80 parts PPS 309 and 20 parts Masterbatch A) were metered into a Werner and Pfleiderer 28 mm twin screw extruder and spun through a 34-hole spinneret orifice of 0.012 inch (0.030 mm) diameter and 0.048 inch (1.22 mm) length. The extruder was heated in the feed zone to 190° C. then to melt zones at 275 then 285° C., then transfer zones at 285° C. and then to Zenith pumps (available Zenith Pumps, Monroe, N.C.) at 285° C. and then pushed and transferred to the spinneret pack block at 290° C. A ring heater was used at 290° C. around the pack nut that holds the spinneret. After simple cross flow air quenching, the undrawn yarns were processed as described below. The wind up unit was a Barmag SW 6.

The speed of the gear pump on the sheath side was preset so as to supply 32.8 g/min of the PPS to the spinneret. The polymer stream was filtered through three 200 mesh screens sandwiched between 50 mesh screens within the pack, and after filtration, a total of 34 individual fibers/filaments were created at the spinneret orifice outlets with the sheath-core cross section. These 34 resulting filaments were cooled in ambient air quench zone, given an aqueous oil emulsion (10% oil) finish, and then combined in a guide approximately eight feet (˜7 meters) below the spin pack. The 34 filament yarn was pulled away from the spinneret orifices and through the guide by a roll with an idler roll turning at approximately 527 meters/minute. From these rolls the yarn was taken to a pair of rolls also at 537 meters/minute, then through a steam jet at 170 C, then to a pair of rolls at 1900 meters/minute heated at 125° C., then to a pair of rolls at 1900 meters/minute at room temperature then to a pair of let down rolls and to the windup. The denier on this fiber was 115.

### Fiber Example A

In this example, a bicomponent fiber was made from polyphenylene sulfide component as the core and polymethyl pentene as the sheath. The polyphenylene sulfide (PPS) resin is available from Ticona as Fortran PPS 309. The polymethyl pentene (PMP) resin is available from Mitsui Chemicals America as DX820. Before fibers were spun the resin was dried for 16 hours at 100° C. in a vacuum oven with a dry nitrogen sweep. The dried polymer pellets were metered into two separate Werner and Pfleiderer 28 mm twin screw extruder (one for the core and the other for the sheath) and spun through a 34-hole spinneret orifice of 0.012 inch (0.030 mm) diameter and 0.048 inch (1.22 mm) length. The extruder feeding the sheath side containing polymethyl pentene was heated in the feed zone to 200° C. then to melt zones at 245 then 275° C., then transfer zones at 275° C. and then to Zenith pumps (available Zenith Pumps, Monroe, N.C.) at 275° C. and then pushed and transferred to the spinneret pack block at 290° C. The extruder feeding the core section containing polyphenylene sulfide was heated in the feed zone to 190° C. then to melt zones at 275 then 285° C., then transfer zones at 285° C. and then to Zenith pumps (available Zenith Pumps, Monroe, N.C.) at 285° C. and then pushed and transferred to the spinneret pack block at 290° C. A ring heater was used at 290° C. around the pack nut that holds the spinneret. After simple cross flow air quenching, the undrawn yarns were processed as described below. The wind up unit was a Barmag SW 6.

The speed of the gear pump on the sheath side was preset so as to supply required amount of PMP while the gear pump on the core side was preset to required amount of the PPS to the spinneret. The polymer stream was filtered through three 200 mesh screens sandwiched between 50 mesh screens within the pack, and after filtration, a total of 34 individual fibers/filaments were created at the spinneret orifice outlets with the sheath-core cross section. These 34 resulting filaments were cooled in ambient air quench zone, given an aqueous oil emulsion (10% oil) finish, and then combined in a guide approximately eight feet (˜7 meters) below the spin pack. The 34 filament yarn was pulled away from the spinneret orifices and through the guide by a roll with an idler roll turning at approximately 540 meters/minute. From these rolls the yarn was taken to a pair of rolls also at 540 meters/minute, then through a steam jet at 170 C, then to a pair of rolls at 1800 meters/minute heated at 125° C., then to a pair of rolls at 1800 meters/minute at room temperature then to a pair of let down rolls and to the windup.

| | |
|---|---|
| Composition (weight % based | Basis |
| on the total weight of the fiber) | weight |

| | | | |
|---|---|---|---|
| Example # | Sheath | Core | (denier) |

| | | | | |
|---|---|---|---|---|
| A | A-1 | 30% PMP | 70% PPS | 122 |
| | A-2 | 25% PMP | 75% PPS | 121 |
| | A-3 | 20% PMP | 80% PPS | 122 |

### Fiber Example B

In this example, a bicomponent fiber was made from polyphenylene sulfide containing zinc ethylhexanoate stabilizer component as the core and polymethyl pentene (PMP) as the sheath. Before fibers were spun the PMP, PPS and Masterbatch A resin were dried for 16 hours at 100° C. in a vacuum oven with a dry nitrogen sweep.

The dried polymer pellets were metered into two separate Werner and Pfleiderer 28 mm twin screw extruder (one for the core and the other for the sheath) and spun through a 34-hole spinneret orifice of 0.012 inch (0.030 mm) diameter and 0.048 inch (1.22 mm) length. The extruder feeding the sheath side containing polymethyl pentene was heated in the feed zone to 200° C. then to melt zones at 245 then 275° C., then transfer zones at 275° C. and then to Zenith pumps (available Zenith Pumps, Monroe, N.C.) at 275° C. and then pushed and transferred to the spinneret pack block at 290° C.

A blend of PPS resin (80 wt %) and Masterbatch A (20 wt %) was fed into the extruder feeding the core section. This extruder was heated in the feed zone to 190° C. then to melt zones at 275 then 285° C., then transfer zones at 285° C. and then to Zenith pumps (available Zenith Pumps, Monroe, N.C.) at 285° C. and then pushed and transferred to the spinneret pack block at 290° C. A ring heater was used at 290° C. around the pack nut that holds the spinneret. After simple cross flow air quenching, the undrawn yarns were processed as described below. The wind up unit was a Barmag SW 6.

The speed of the gear pump on the sheath side was preset so as to supply required amount of PMP while the gear pump on the core side was preset to required amount of the PPS to the spinneret. The polymer stream was filtered through three 200 mesh screens sandwiched between 50 mesh screens within the pack, and after filtration, a total of 34 individual fibers/filaments were created at the spinneret orifice outlets with the sheath-core cross section. These 34 resulting filaments were cooled in ambient air quench zone, given an aqueous oil emulsion (10% oil) finish, and then combined in a guide approximately eight feet (˜7 meters) below the spin pack. The 34 filament yarn was pulled away from the spinneret orifices and through the guide by a roll with an idler roll turning at approximately 540 meters/minute. From these rolls the yarn was taken to a pair of rolls also at 540 meters/minute, then through a steam jet at 170 C, then to a pair of rolls at 1800 meters/minute heated at 125° C., then to a pair of rolls at 1800 meters/minute at room temperature then to a pair of let down rolls and to the windup.

| | | Composition (weight % based | | Basis |
|---|---|---|---|---|
| | | on the total weight of the fiber) | | weight |
| Example # | | Sheath | Core | (denier) |
| B | B-1 | 30% PMP | 70% PPS (2.2% Zinc Octoate) | 122 |
| | B-2 | 25% PMP | 75% PPS (2.2% Zinc Octoate) | 121 |
| | B-3 | 20% PMP | 80% PPS (2.2% Zinc Octoate) | 122 |

### Acid Test Experiment on the Fibers

A bicomponent fiber, approximately 2 meter in length, prepared by the above mentioned process is wound on glass rod. The glass rod with the fiber is placed in a vial containing an acid mixture. The acid mixture is made up of 10:40:50 wt % of nitric acid (70% concentrated), sulfuric acid (98% concentrated) and distilled water respectively. Care is taken to ensure that the fibers are not in direct contact with the acid solution. The vial is sealed with a cap once the glass rod with the fiber is placed inside it. The sealed vial containing the fiber is placed in a mantle with slots for the vials and heated to 120° C. The vials with the fiber samples are removed for testing at an interval of two, four and six hours. The fibers are then rinsed with water several times, dried in air overnight and unwound carefully. The unwound fibers are then tested for tenacity and elongation.

Table 1 summarizes the sample types.

TABLE 1

| Sample | Core | Sheath |
|---|---|---|
| Comp 1 | PPS | NA |
| Comp 2 | PPS (2.2% Zinc Octoate) | NA |
| A-1 | 70% PPS | 30% PMP |
| A-2 | 75% PPS | 25% PMP |
| A-3 | 80% PPS | 20% PMP |
| B-1 | 70% PPS (2.2% Zinc Octoate) | 30% PMP |
| B-2 | 75% PPS (2.2% Zinc Octoate) | 25% PMP |
| B-3 | 80% PPS (2.2% Zinc Octoate) | 20% PMP |

The results of tenacity and elongation testing on these treated and untreated fibers are given in the table below. Tenacity and elongation of the fibers were measured on an Instron-type testing machine with a gage length of 10 cm, test speed of 6 inch/min in accordance with ASTM D2256.

TABLE 2
Tenacity and tenacity retention of the fibers treated with the acid mixture at 0, 2,
4 and 6 hrs

| | Time | | | | | | | |
|---|---|---|---|---|---|---|---|---|
| | 0 hrs | | 2 hrs | | 4 hrs | | 6 hrs | |
| | | tenacity | | tenacity | | tenacity | | tenacity |
| Sample | tenacity | retention | tenacity | retention | tenacity | retention | tenacity | retention |
| ID | (g/den) | (%) | (g/den) | (%) | (g/den) | (%) | (gpf) | (%) |
| Comp 1 | 3.24 | 100 | 2.49 | 76.9 | 2.46 | 75.9 | 1.98 | 61.1 |
| Comp 2 | 3.17 | 100 | 2.63 | 82.9 | 2.33 | 73.5 | 1.85 | 58.4 |
| A-1 | 3.58 | 100 | 3.73 | 104.2 | 3.63 | 101.4 | 3.42 | 95.5 |
| A-2 | 3.68 | 100 | 3.4 | 92.4 | 3.15 | 85.6 | 2.96 | 80.4 |
| A-3 | 3.8 | 100 | 3.2 | 83.9 | 3.4 | 89.5 | 3.34 | 87.9 |
| B-1 | 3.41 | 100 | 3.34 | 97.9 | 3.15 | 92.4 | 3.04 | 87.1 |
| B-2 | 3.51 | 100 | 3.32 | 94.6 | 3.04 | 86.6 | 2.72 | 77.5 |
| B-3 | 3.56 | 100 | 3.28 | 92.1 | 3.07 | 86.2 | 3.12 | 87.6 |

TABLE 3
Elongation and elongation retention of the fibers treated with the acid mixture at 0,
2, 4 and 6 hrs

| | Time | | | | | | | |
|---|---|---|---|---|---|---|---|---|
| | 0 hrs | | 2 hrs | | 4 hrs | | 6 hrs | |
| | | elongation | | elongation | | elongation | | elongation |
| Sample | elongation | retention | elongation | retention | elongation | retention | elongation | retention |
| ID | (%) | (%) | (%) | (%) | (%) | (%) | (%) | (%) |
| Comp 1 | 24.9 | 100 | 18.8 | 75.5 | 16.2 | 64.8 | 11.03 | 44.2 |
| Comp 2 | 25.4 | 100 | 19.4 | 76.3 | 15.1 | 59.4 | 11.52 | 45.3 |
| A-1 | 25.6 | 100 | 25.6 | 99.9 | 26.4 | 103.2 | 24.1 | 94.3 |
| A-2 | 24.8 | 100 | 22.7 | 91.6 | 21.5 | 86.8 | 18.92 | 76.5 |
| A-3 | 28.1 | 100 | 21.4 | 72.6 | 15.4 | 76.1 | 22.05 | 78.4 |
| B-1 | 23.1 | 100 | 23.5 | 101.5 | 20.6 | 88.9 | 19.7 | 85.0 |
| B-2 | 25.2 | 100 | 22.6 | 89.7 | 20.0 | 79.5 | 17.21 | 68.3 |
| B-3 | 26.4 | 100 | 22.2 | 84.1 | 19.6 | 74.4 | 21.08 | 79.9 |

Tables 2 and 3 show the ability of the fibers of the invention to resist an acid environment at the temperature of the test. Tenacity retention in the absence of the PMP coating after 6 hours is around 60%, while in the coated samples it goes up to around 80%. A similar trend is seen with elongation.

We claim:

1. A multicomponent fiber having an exposed outer surface, said fiber comprising: at least a first component of polyarylene sulfide polymer; and at least a second component of a thermoplastic polymer free of polyarylene sulfide polymer, wherein said thermoplastic polymer forms the entire exposed surface of the multicomponent fiber and consists essentially of polymethylpentene.

2. The fiber of claim 1, wherein said polyarylene sulfide polymer comprises a polymer in which at least 85 mol % of the sulfide linkages are attached directly to two aromatic rings.

3. The fiber of claim 2, wherein said polyarylene sulfide polymer is polyphenylene sulfide.

4. The fiber of claim 1, wherein said second component is present at a 10 to 30% by weight of the total polyarylene sulfide plus thermoplastic polymer.

5. The fiber of claim 1, wherein the second component comprises less than about 30 percent by weight of the total weight of the fiber.

6. The fiber of claim 5, wherein the second component comprises less than about 20 percent by weight of the total weight of the fiber.

7. The fiber of claim 1, wherein said fiber has a circular cross section.

8. The fiber of claim 1, wherein said fiber has a multi-lobal cross section.

9. The fiber of claim 1, wherein said fiber is a continuous filament.

10. The fiber of claim 1, wherein said fiber is a staple fiber.

11. The fiber of claim 1, wherein said fiber is a spunbond fiber.

12. The fiber of claim 1, wherein said fiber is a meltblown fiber.

13. The fiber of claim 1, wherein said fiber is a bicomponent fiber comprising a sheath component and a core component, wherein said sheath component forms the entire exposed outer surface of said fiber and comprises said thermoplastic polymer free of polyarylene sulfide polymer, and wherein said core component comprises polyarylene sulfide polymer.

14. The fiber of claim 22, wherein said bicomponent fiber has a concentric sheath/core cross section.

15. The fiber of claim 22, wherein said bicomponent fiber has an eccentric sheath/core cross section.

16. The fiber of claim 1, wherein said fiber is an islands-in-the-sea fiber comprising a sea component and a plurality of island components distributed within said sea component, wherein said sea component forms the entire exposed outer surface of said fiber and comprises said thermoplastic polymer free of polyarylene sulfide polymer, and wherein said plurality of island components comprises polyarylene sulfide polymer.

17. A web comprising the fiber of claim 1.

18. The web of claim 17, wherein the web comprises a woven or nonwoven material.

19. The web of claim 18, wherein the web is made from a spunbond or meltblown process.

20. A method for improving the acid resistance of a fiber, comprising the steps of;
providing a fiber,
coating the fiber with a thermoplastic polymer that is free of polyarylene sulfide polymer to from a coated fiber, wherein said thermoplastic polymer forms the entire exposed surface of the coated fiber and consists essentially of polymethylpentene, and
said fiber comprises at least a first component of polyarylene sulfide polymer.
